(19) United States
(12) Patent Application Publication
(10) Pub. No.: US 2005/0050973 A1
(43) Pub. Date: Mar. 10, 2005

(54) Device for converting rotary motion into translational motion

(75) Inventors: Armin Olschewski, Schweinfurt (DE); Manfred Brandenstein, Eussenheim (DE); Barbara Faltus, Gochsheim (DE); Hauke Hans, Ulm (DE); Koos Zwarts, VA Nieuwegein (NL)

Correspondence Address: BURNS DOANE SWECKER & MATHIS L L P, POST OFFICE BOX 1404, ALEXANDRIA, VA, 22313-1404, US

(73) Assignee: AB SKF, Goteborg (SE)

(21) Appl. No.: 10/895,127

(22) Filed: Jul. 21, 2004

(30) Foreign Application Priority Data
Jul. 21, 2003 (DE) 103 33 268.5

(51) Int. Cl. F16H 25/08

(52) U.S. Cl. 74/57

(57) ABSTRACT

A device for converting rotary motion into translational motion comprises a first component and a second component, with the second component being arranged to be able to turn around an axis of rotation relative to the first component and to move in the axial direction. Each component is provided with at least one track in which are arranged roll bodies. To produce a relatively high axial force with relatively small dimensions of the device, the tracks are arranged at opposing faces of the two components, with the tracks extending in a circle around the axis of rotation and in a spiral manner with a given pitch over the periphery of the components.

This application is based on and claims priority under 35 U.S.C. §119 with respect to German Application No. 103 33 268.5 filed on Jul. 21, 2003, the entire content of which is incorporated herein by reference.

### FIELD OF THE INVENTION

The invention generally relates to a device for converting rotary motion into translational motion. More specifically, the invention pertains to a device for converting rotary motion into translational motion in which two components are positioned in opposing relation to one another, with each component having at least one track for roll bodies.

### BACKGROUND OF THE INVENTION

There are a variety of known devices which are adapted to convert rotary motion into axial motions. For example, spherical roll spindles are known which have components which are arranged to be able to turn relative to one another and which each have tracks for balls. These tracks are arranged in a spiral shape around the axis of rotation so that upon relative rotation of the two components to one another, an axial displacement is induced.

In some applications special demands are imposed on these known devices for conversion of rotary motion into translational motion. For example, in axle gearing, especially in rear axle gearing, it is occasionally necessary, in order to implement a differential lock or differential brake, to have available such devices which produce very large forces in the axial direction, with extremely small dimensions and especially very small axial structural heights. Even if the previously known devices were fundamentally suited for these applications, they are excluded based on the indicated requirements.

DE 199 42 462 C1, DE 100 25 078 C1 and DE 698 03 527 T2 each disclose devices for conversion of rotary motion into translational motion. Here it is always provided that a component which is to be axially moved on one face has several sections which are arranged or distributed over the periphery and which run helically. While a relatively stable arrangement is achieved, the axial forces which can be produced are limited depending on the required axial adjustment motion and depending on the available structural space when two components which can be moved axially relative to one another turn by a given angle of rotation.

### SUMMARY

According to one aspect, a device for converting rotary motion into translational motion comprises a first component possessing a face and a second component possessing a face and arranged to turn around an axis of rotation relative to the first component and to move in an axial direction. The first and second components are arranged relative to one another such that the face of the first component opposes the face of the second component, with the face of each component comprising at least one track. Roll bodies are positioned between the first and second components and are arranged in the tracks of the first and second components. The track of the first component and the track of the second component s extend in a circle around the axis of rotation, and extend in a spiral with a given pitch over a periphery of the respective first and second components, with the tracks at a single peripheral point of the two components possess a substantially axially aligned step. A cage is provided to guide the roll bodies, and the cage at a single peripheral point possesses an interruption allowing an offset in the axial direction.

To produce the axial displacement motion as the two components rotate in relative terms to one another, a track which runs in a spiral is thus provided, over the pitch of which the step-up ratio of rotary motion into axial displacement motion can be quite accurately adjusted with a relatively high intensification of force.

The first and second components can be made annular in shape and can have a hole with an inside diameter. The roll bodies are preferably in the form of balls. As an alternative, the roll bodies can be in the form of needles with an axis of rotation which is perpendicular to the axis of rotation of one component.

For many applications, it has been found useful to configure the tracks so that the pitch of the spiral-running tracks of the two components is between 1 mm and 10 mm. According to another advantageous configuration, the pitch of the spiral-running tracks of the two components can be between 1% and 10% of the inside diameter of the annular components.

According to another aspect, a device for converting rotary motion into translational motion comprises a first annular component and a second annular component adapted to rotate around an axis of rotation relative to the first component and to move in an axial direction relative to the first component, with the first and second components being positioned in opposing relation to one another and each provided with at least one respective track extending in a circular manner about the axis of rotation. A plurality of roll bodies are positioned between the first and second components, with each of the roll bodies being arranged in the track of the first component and the track of the second component. The track of the first component and the track of the second component extend in a spiral manner, with the track of the first component and the track of the second component each possessing no more than one step along their entire circumferential extent. In addition, the plurality of roll bodies can be positioned in a cage located between the first and second components.

### BRIEF DESCRIPTION OF THE DRAWING FIGURES

The foregoing and additional features of the present invention will become more apparent from the following detailed description considered with reference to the accompanying drawing figures in which like elements are designated by like reference numerals.

FIG. 1 is an exploded perspective view of a device for converting rotary motion into translational motion according to a disclosed embodiment of the invention.

FIG. 2 is a side view of the device shown in FIG. 1

FIG. 3 is a three-dimensional side view of a first component of the device shown in FIG. 1.

FIG. 4 is a three-dimensional side view similar to FIG. 3 illustrating a cage seated on the first component together with roll bodies.

FIG. 5 is a plan view of the first component as seen from the direction X in FIG. 3

FIG. 6 is a cross-sectional view of a portion of the first component taken along the section line 6-6 in FIG. 5.

FIG. 7 is a side view of the device shown in FIG. 2 as seen from the direction Y in FIG. 2.

### DETAILED DESCRIPTION

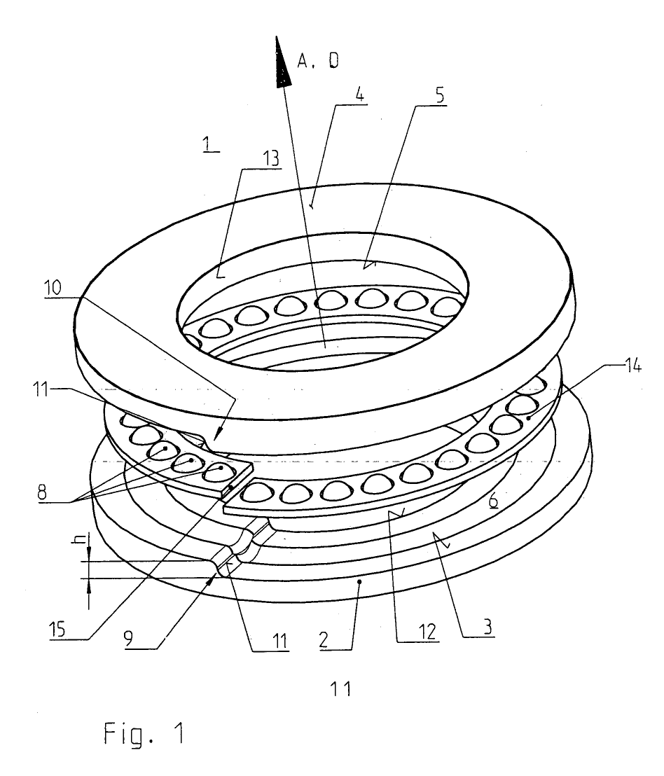

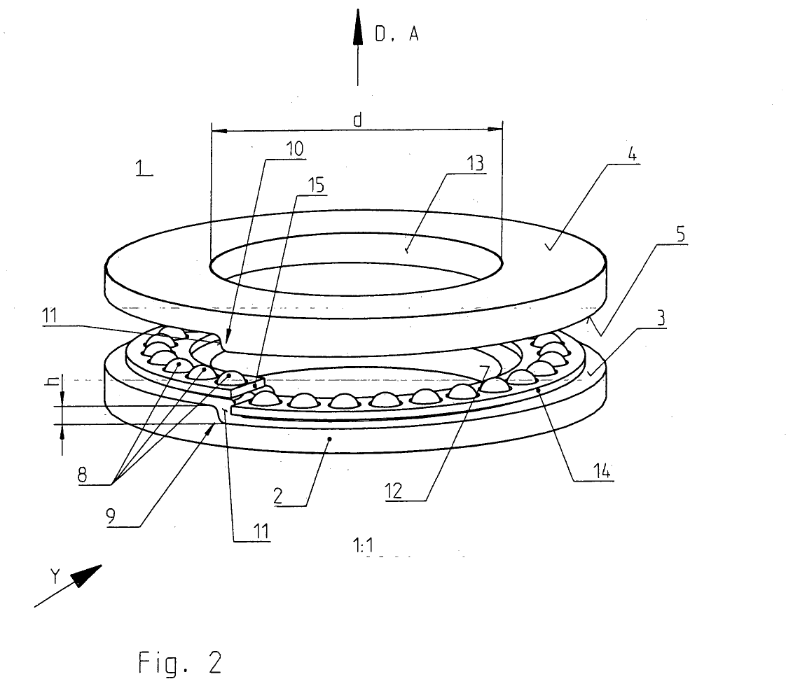

FIGS. 1 and 2 illustrate a device 1 for converting a rotary motion into translational motion. The device 1 generally comprises two components, namely a first component 2 and a second component 4. In the illustrated embodiment, both components 2, 4 are ring-shaped or possess an annular shape and possess an inside diameter d.

The two components 2, 4 are turned relative to one another by a drive device around the axis D of rotation. The drive device for rotating one of the components 2, 4 is designed such that rotary motion of the two components 2, 4 relative to one another takes place by an angle up to 180°. During this relative motion, the two components 2, 4 are pressed axially apart, i.e. one component 4 is shifted relative to the other component 2 in the axial direction A.

For this purpose the two components 2, 4 have opposing faces 3, 5 in which are machined respective tracks 6, 7. Roll bodies 8, which in the illustrated version are in the form of balls, can be located in these tracks 6, 7. The roll bodies 8 therefore keep the two components 2, 4 at a distance relative to one another in the axial direction A.

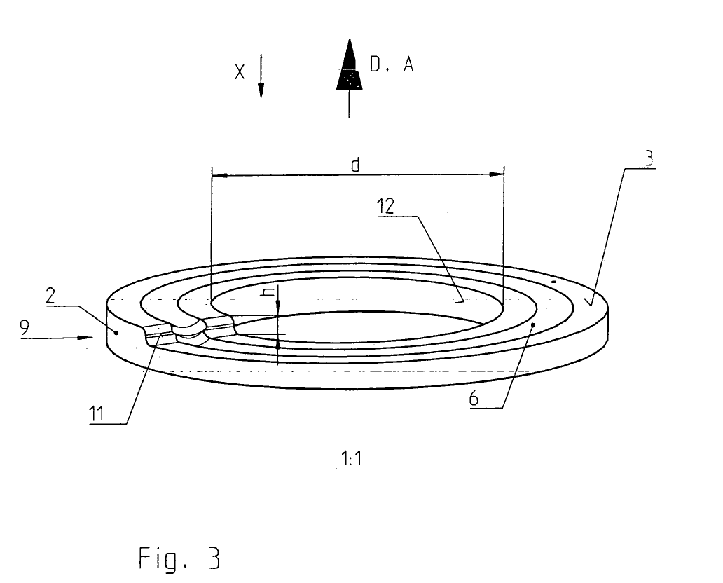

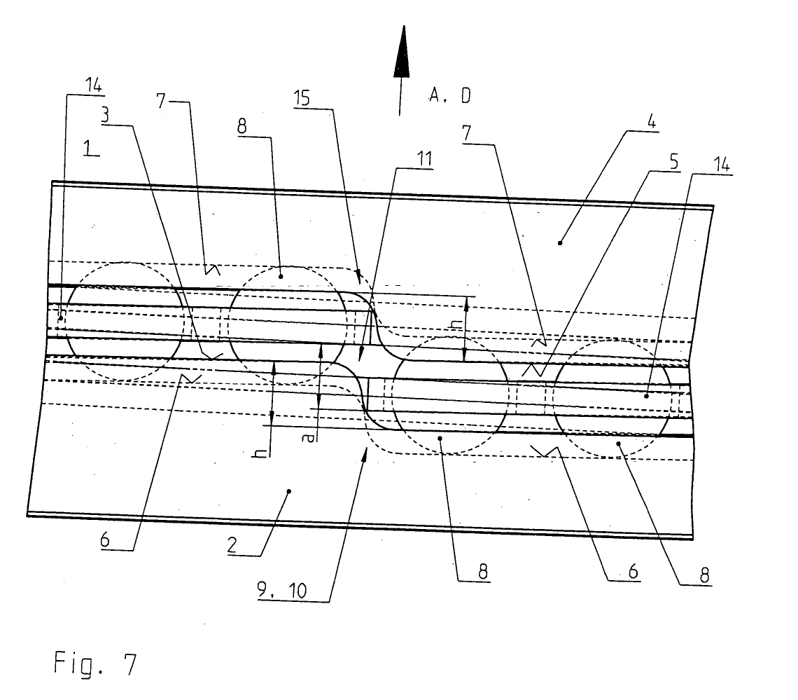

As can be further seen, particularly with reference to FIGS. 3, 6 and 7, the respective tracks 6, 7 in the two components 2, 4 run or extend in a circle around the axis D of rotation and in a spiral with a given pitch h over the periphery of the components 2, 4. This yields a step 11 at one peripheral point 9, 10 of each respective component 2, 4 so that the tracks 6, 7 of the respective components 2, 4 have respective substantially axially aligned steps 11 at a single peripheral point 9, 10. Thus, each track 6, 7 extends from a lowest most point immediately on one side of the step 11 to a highest most point immediately on an opposite side of the step 11, with the elevational height of each track gradually rising from the lowest most point to the highest most point in a spiral fashion. As shown in FIG. 2, the two components 2, 4 are made congruent to one another, i.e. they complement one another. As a result of the helical or spiral run of the tracks 6, 7 the two components 2, 4 in the indicated relative rotation around the axis D of rotation are moved apart from one another according to the pitch h of the spiral. As illustrated, each of the tracks possesses no more than one step. Also, in the illustrated embodiment, the tracks 6, 7 are continuous.

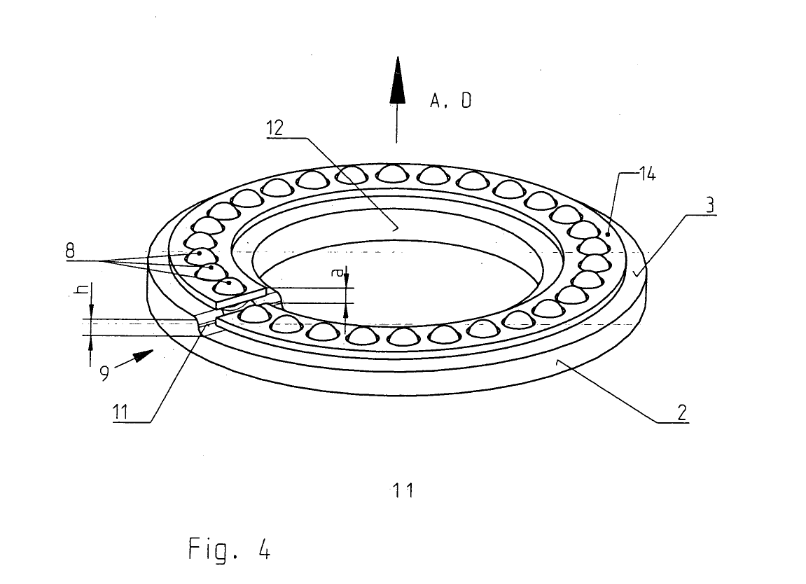

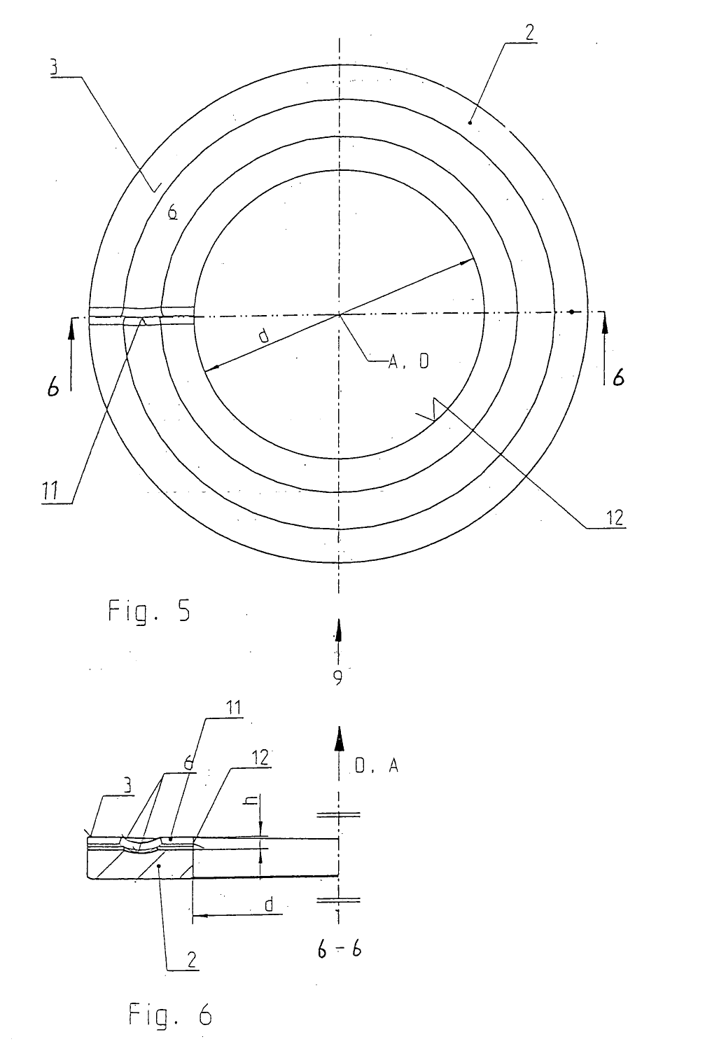

A cage 14, formed as a generally annular or ring-shaped cage in the illustrated embodiment, is also provided to guide the roll bodies 8. The roll bodies 8 are received in respective openings in the cage 14 as shown in FIGS. 1, 2 and 4. One peripheral point 15 of the cage 14 has an interruption which allows an offset a in the axial direction A as shown in FIG. 7. At the interruption, the cage 14 thus possesses free ends that are axially offset. This interruption of the cage 14 ensures that the step 11 is overcome when the two components 2, 4 turn relative to one another. The cage 14 together with the roll bodies 8 rotates by half the angle of rotation as the second component 4 turns relative to the first component 2. In this way, some of the roll bodies 8 are displaced into a non-bearing area. In order to achieve very high axial forces, it is preferable that there be as large a number of roll bodies 8 as possible. It is preferable to include at least 10 roll bodies, preferably at least 20.

With respect to the layout of the pitch h, a value between 1 mm and 10 mm has proven effective. Preferably, the pitch h is between 1% and 10% of the inside diameter d of the holes or openings 12, 13 in the two components 2, 4.

As described above, the roll bodies in the illustrated embodiment are in the form of balls. However, the roll bodies can take other forms. For example, according to an alternative embodiment, the roll bodies of the device can be in the form of needles having an axis of rotation which is perpendicular to the axis of rotation of one component.

The device for converting rotary motion into translational motion is used preferably as a component of a differential lock or differential brake of an axle transmission, especially of a rear axle transmission, of a motor vehicle. The device can also be used very advantageously in the braking device of a motor vehicle.

The device for converting rotary motion into translational motion provides a relatively compact unit with an especially axially small structure. The device nevertheless makes it possible to achieve relatively high axial forces by relative rotation of the two parts.

The device configured in the manner according to the described and illustrated embodiment is such that with the corresponding geometrical layout of the spiral path of the tracks, as the two components execute relative rotation-to one another, an axial displacement of the two components to one another takes place, in which relatively high forces can be produced The entire arrangement can be made as an annular unit which has a relatively small axial extension, thus allowing it to be especially well suited for, by way of example, the indicated applications.

The principles, preferred embodiment and mode of operation have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A device for converting rotary motion into translational motion comprising:
a first component possessing a face;
a second component possessing a face and arranged to turn around an axis of rotation relative to the first component and to move in an axial direction;
the first and second components being arranged relative to one another such that the face of the first component opposes the face of the second component;
the face of the first component comprising at least one track and the face of the second component comprising at least one track;
a plurality of roll bodies positioned between the first and second components and arranged in the tracks of the first and second components;
the track of the first component and the track of the second component s extending in a circle around the axis of rotation;
the track of the first component and the track of the second component extending in a spiral with a given pitch over a periphery of the respective first and second components;
the tracks at a single peripheral point of the two components possessing a substantially axially aligned step;
a cage which guides the roll bodies; and
the cage at a single peripheral point having an interruption allowing an offset in the axial direction.

2. The device according to claim 1, wherein the first and second components are ring-shaped and possess a hole with an inside diameter.

3. The device according to claim 2, wherein the roll bodies are balls.

4. The device according to claim 3, wherein the spiral extending track of each of the first and second components possesses a pitch between 1 mm and 10 mm.

5. The device according to claim 3, wherein the spiral extending track of each of the first and second components possesses a pitch between 1% and 10% of an inside diameter of the first and second ring-shaped components.

6. The device according to claim 1, wherein the roll bodies are balls.

7. The device according to claim 1, wherein the spiral extending track of each of the first and second components possesses a pitch between 1 mm and 10 mm.

8. The device according to claim 1, wherein the spiral extending track of each of the first and second components possesses a pitch between 1% and 10% of an inside diameter of the first and second ring-shaped components.

9. A device for converting rotary motion into translational motion comprising:
a first annular component;
a second annular component adapted to rotate around an axis of rotation relative to the first component and to move in an axial direction relative to the first component;
the first and second components being positioned in opposing relation to one another and each provided with at least one respective track extending in a circular manner about the axis of rotation;
a plurality of roll bodies between the first and second components, each of the roll bodies being arranged in the track of the first component and the track of the second component;
the track of the first component and the track of the second component extending in a spiral manner, with the track of the first component and the track of the second component each possessing no more than one step along their entire circumferential extent; and
the plurality of roll bodies being positioned in a cage located between the first and second components.

10. The device according to claim 9, wherein the roll bodies are balls.

11. The device according to claim 10, wherein the spiral extending track of each of the first and second components possesses a pitch between 1 mm and 10 mm.

12. The device according to claim 11, wherein the cage possesses an interruption about its peripheral extent defining free ends of the cage that are offset in the axial direction.

13. The device according to claim 10, wherein the spiral extending track of each of the first and second components possesses a pitch between 1% and 10% of an inside diameter of the first and second ring-shaped components.

14. The device according to claim 13, wherein the cage possesses an interruption about its peripheral extent defining free ends of the cage that are offset in the axial direction.

15. The device according to claim 9, wherein the spiral extending track of each of the first and second components possesses a pitch between 1 mm and 10 mm.

16. The device according to claim 9, wherein the spiral extending track of each of the first and second components possesses a pitch between 1% and 10% of an inside diameter of the first and second ring-shaped components.

17. The device according to claim 9, wherein the cage possesses an interruption about its peripheral extent defining free ends of the cage that are offset in the axial direction.

18. The device according to claim 9, wherein the cage possesses no more than one interruption.

19. The device according to claim 9, wherein the track of each of the first and second components is continuous.
